(19) United States
(12) Patent Application Publication
(10) Pub. No.: US 2009/0080412 A1
(43) Pub. Date: Mar. 26, 2009

(54) COMMUNICATION APPARATUS AND COMMUNICATION CONTROL METHOD

(75) Inventors: SEIJIRO YONEYAMA, Yokohama-shi (JP); KOTARO ISE, Saitama-shi (JP)

Correspondence Address: Charles N.J. Ruggiero, Esq.;Ohlandt, Greely, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/233,418

(22) Filed: Sep. 18, 2008

(30) Foreign Application Priority Data
Sep. 26, 2007 (JP) 2007-249503

(51) Int. Cl. H04L 12/66

(52) U.S. Cl. 370/352

(57) ABSTRACT

A communication apparatus for dividing voice data into a plurality of packets and transmitting the packets to a destination communication apparatus includes a detection unit configured to detect one of predetermined events which are triggers of change processing of a packet division length used for the dividing, a determination unit configured to determine, when the detection unit detects the one of the predetermined events, a possible range of the packet division length after the change processing based on predetermined external information which influence the packet division length, a negotiation unit configured to negotiate the packet division length after the change processing with the destination communication apparatus based on the range determined by the determination unit, and, a control unit configured to control the packet transmission based on the packet division length negotiated by the negotiation unit.

### CROSS-REFERENCE TO RELATED APPLICATIONS

This application is based upon and claims the benefit of priority from prior Japanese Patent Application No. 2007-249503, filed Sep. 26, 2007, the entire contents of which are incorporated herein by reference.

### BACKGROUND OF THE INVENTION

1. Field of the Invention

The present invention relates to a communication apparatus and communication control method.

2. Description of the Related Art

There exists an IP phone system as a conventional voice transmitting apparatus. The IP phone system is implemented by using an origination/termination technique employing SIP (Session Initiation Protocol) and a voice transmission technique employing RTP (Real-time Transport Protocol) (see “RTP: A Transport Protocol for Real-Time Applications.; IETF RFC 3550; H. Schulzrinne, S. Casner, R. Frederick, V. Jacobson. July 2003.”, and “SDP: Session Description Protocol.; IETF RFC 4566; M. Handley, V. Jacobson, C. Perkins. July 2006.”)

In the IP phone system, upon origination/termination, IP phone terminals use SDP (Session Description Protocol) to negotiate media information they support with each other, and establish a media session between themselves. During the media session, voice data is generally RTP-packetized at an interval of 20 msec and then transmitted.

In a embedded device, however, since the interrupt load of packet processing is high, it is undesirable to divide voice data into small packets and transfer them. In particular, in a device with low and limited throughput, the operation of other communication processes and application processes (e.g., an address book application) may suffer.

On the other hand, in a scheme of increasing the packet division length of voice data and transferring the voice data, a buffering time of the voice data is prolonged. This prolongs the delay of voice transmission, thereby deteriorating the voice quality.

In a conventional technique, when a device with low and limited throughput uses the scheme of dividing voice data into small packets and transferring them, other communication processes and application processes suffer. Furthermore, the scheme of increasing the packet division length and transferring the voice data causes the voice quality to deteriorate.

### BRIEF SUMMARY OF THE INVENTION

According to an aspect of the present invention, there is provided a communication apparatus for dividing voice data into a plurality of packets and transmitting the packets to a destination communication apparatus which includes, a detection unit configured to detect one of predetermined events which are triggers of change processing of a packet division length used for the dividing, a determination unit configured to determine, when the detection unit detects the one of the predetermined events, a possible range of the packet division length after the change processing based on predetermined external information which influence the packet division length, a negotiation unit configured to negotiate the packet division length after the change processing with the destination communication apparatus based on the range determined by the determination unit, and a control unit configured to control the packet transmission based on the packet division length negotiated by the negotiation unit.

### BRIEF DESCRIPTION OF THE SEVERAL VIEWS OF THE DRAWING

FIG. 1 is a view showing an example of a configuration of a communication system according to an embodiment;

FIG. 2 is a block diagram showing an example of a configuration of a communication apparatus according to the embodiment;

FIG. 3 is a flowchart showing an example of an operation procedure when the communication apparatus detects the start of change processing;

FIG. 4 is a flowchart showing an example of a processing procedure of determining a minimum value of the packet division length of the communication apparatus;

FIG. 5 is a sequence chart showing an example of an operation sequence for negotiation executed between communication apparatuses according to the embodiment; and

FIG. 6 is a sequence chart showing an example of an operation sequence for negotiation executed between the communication apparatuses according to the embodiment.

### DETAILED DESCRIPTION OF THE INVENTION

An embodiment of the present invention will be described below with reference to the accompanying drawings.

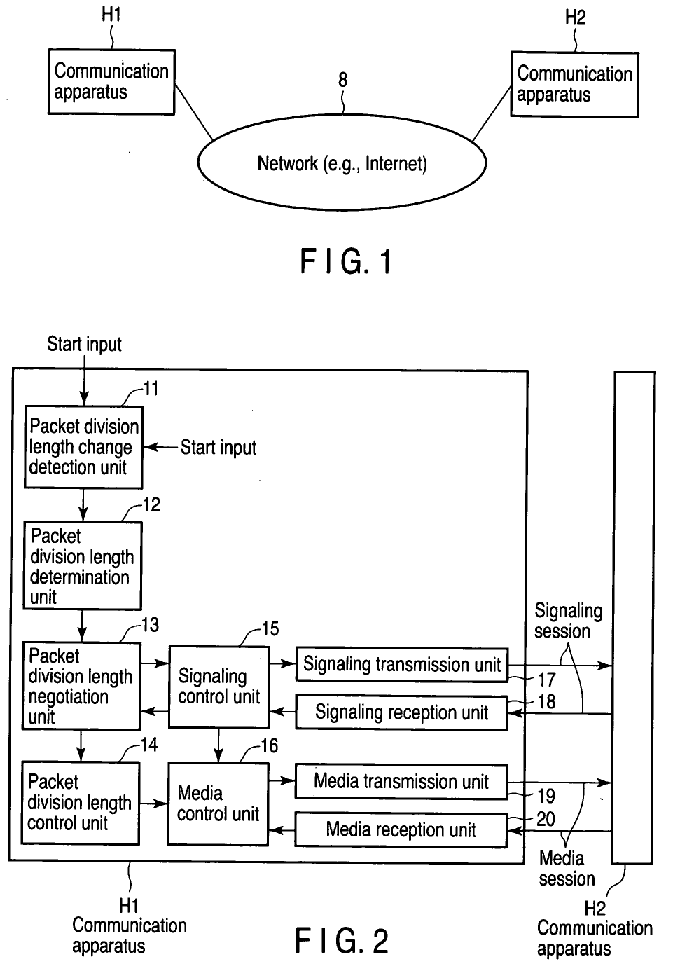

Referring to FIG. 1, reference numeral 8 denotes a network. Reference symbols H1 and H2 denote communication apparatuses (hosts) connected to the network 8.

Note that although only two communication apparatuses are shown in the network 8 of FIG. 1, there may be three or more communication apparatuses communicable with each other.

In this embodiment, a case in which the network 8 is the Internet will be described as an example. A case in which the communication network serves as an IP phone system and the communication apparatuses H1 and H2 serve as IP phone terminals will be explained by way of example.

A case in which the communication apparatus H1 is on the originating side and the communication apparatus H2 is on the terminating side will be described below as an example.

FIG. 2 shows a configuration of the communication apparatus H1.

As shown in FIG. 2, the communication apparatus H1 comprises a packet division length change detection unit 11, packet division length determination unit 12, packet division length negotiation unit 13, packet division length control unit 14, signaling control unit 15, media control unit 16, signaling transmission unit 17, signaling reception unit 18, media transmission unit 19, and media reception unit 20.

The packet division length change detection unit 11 detects the start of changing the packet division length of voice data (to be referred to as a change start hereinafter). Upon detection of a change start, the packet division length change detection unit 11 instructs the packet division length determination unit 12 to start change processing.

The packet division length determination unit 12 determines the packet division length on the basis of external information which has been set in advance as information influencing a packet division length.

The packet division length negotiation unit 13 negotiates the packet division length with a communication apparatus as a destination.

The packet division length control unit 14 controls voice transmission on the basis of the negotiated packet division length.

The signaling control unit 15 controls, e.g., origination, termination, and disconnection of an IP phone with the destination communication apparatus by using signaling.

The media control unit 16 controls transmission/reception of voice data with the destination communication apparatus.

The signaling transmission unit 17 transmits signaling to the destination communication apparatus.

The signaling reception unit 18 receives signaling from the destination communication apparatus.

The media transmission unit 19 transmits voice data to the destination communication apparatus.

The media reception unit 20 receives voice data from the destination communication apparatus.

Note that the configuration of the communication apparatus H2 is basically the same as that in FIG. 2.

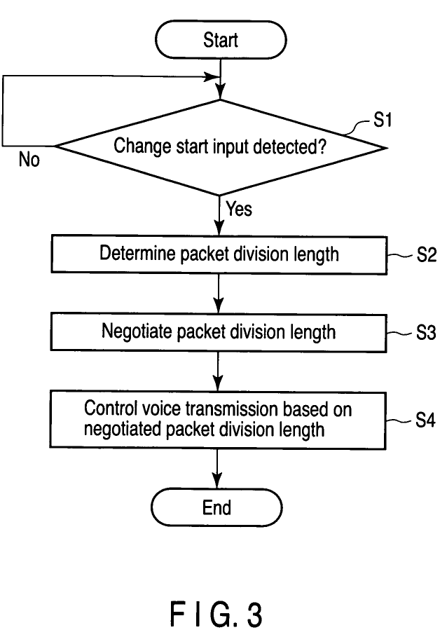

FIG. 3 shows an operation procedure when the communication apparatus H1 detects a change start.

In the communication apparatus H1, when the packet division length change detection unit 11 detects a change start input (step S1), the packet division length determination unit 12 determines a packet division length on the basis of external information (step S2).

The packet division length negotiation unit 13 negotiates the packet division length with the communication apparatus H2 via the signaling control unit 15 (step S3).

The packet division length control unit 14 controls, via the media control unit 16, voice transmission based on the negotiated packet division length with the communication apparatus H2 (step S4).

Note that an operation procedure of the communication apparatus H2 is basically the same as that in FIG. 3.

In the communication apparatus, various pieces of information such as the operation states of other applications and the processing load state of a CPU are available as the external information.

For example, the packet division length change detection unit 11 detects the change start as follows.

When one of predetermined start inputs occurs, for example, the change processing should start. The packet division length change detection unit 11 detects change start by detecting the occurrence of the start inputs.

Examples of the start inputs are as follows.

<Examples of Start Inputs Which Occur Upon Origination/Termination>

(1) In the communication apparatus H1, a call originating operation occurs.

(2) In the communication apparatus H1, a call terminating operation occurs.

<Examples of Start Inputs Which Occur During Telephone Conversation>

(3) In the communication apparatus H1, the number of interrupts per unit time exceeds a threshold value with respect to packet reception processing within the self communication apparatus H1.

(4) In the communication apparatus H1, another application starts.

(5) In the communication apparatus H1, a user inputs a specific instruction.

As for item (5) above, for example, the following method is available. That is, a hardware switch (button) is provided for the phone body of the communication apparatus H1, and when the user presses the button as needed, an event representing that the button has been pressed is detected as a start input. Note that the user need not press the button with the intention of changing the packet division length, and the user presses the button when he/she feels voice quality deterioration.

Items (1) to (5) above are merely examples, and various other start inputs are available.

Which start input is to be employed may be determined as appropriate.

As described above, it is possible to start the change operation of the packet division length not only upon origination but also in a steady state such as during telephone conversation dynamically (automatically or in response to an instruction of the user).

For example, the packet division length determination unit 12 determines the packet division length to be used for negotiation, as follows.

Minimum and maximum values are determined to define the packet division length.

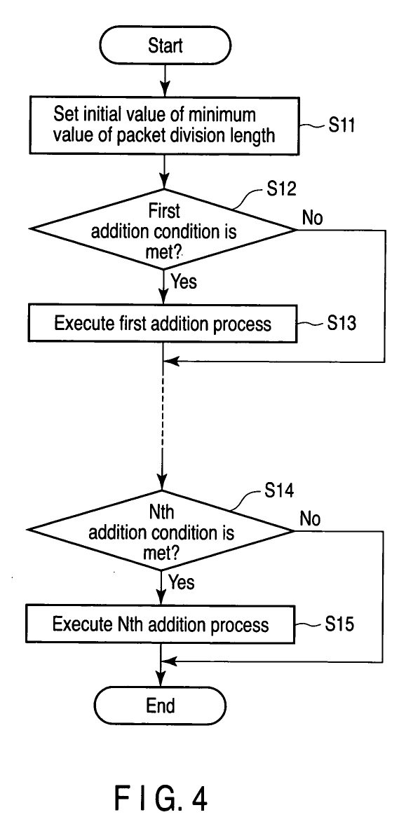

There will now be described a processing procedure of determining the minimum value of the packet division length referring to FIG. 4.

First, the packet division length determination unit 12 sets an initial value of the minimum value of the packet division length (step S11).

If the first predetermined addition condition is met (step S12), the packet division length determination unit 12 executes the first addition process on the minimum value of the packet division length at this time (step S13); otherwise (step S12), the process skips step S13.

The packet division length determination unit 12 repeatedly executes the procedure like steps S12 and S13 until the Nth predetermined addition condition and the Nth addition process (steps S14 and S15).

The maximum value of the packet division length may be determined by, e.g., executing a procedure similar to that in FIG. 4 (i.e., a procedure obtained by substituting subtraction processes for the addition processes in FIG. 4).

Note that the above procedures are merely examples, and the minimum values and/or maximum values may be determined by other procedures.

In this embodiment, the following four kinds of values are determined for the packet division length.

H1s_min: a transmission packet division length (minimum value) of the communication apparatus H1

H1s_max: a transmission packet division length (maximum value) of the communication apparatus H1

H1r_min: a reception packet division length (minimum value) of the communication apparatus H1

H1r_max: a reception packet division length (maximum value) of the communication apparatus H1

In this embodiment, however, a case in which assuming that H1s_min=H1r_min and H1s_max=H1r_max, the two values of H1s_min=H1r_min and H1s_max=H1r_max are calculated will be described by way of example, since it is generally assumed that H1s_min=H1r_min and H1s_max=H1r_max in a typical system configuration.

In this case, H1s_min, H1s_max, H1r_min, and H1r_max may be individually calculated (the result is that H1s_min=H1r min and H1s_max=H1r max).

There is also a case in which it is preferable to individually calculate H1s_min, H1s_max, H1r_min, and H1r_max, e.g., when a codec used for transmission is different from that used for reception or when IPv6 path MTU for transmission is different from that for reception. In this case, although a calculation method of H1s_min may be the same as that of H1r_min, for example, the above initial value and/or addition value for transmission are different from those for reception. The same goes with H1s_max and H1r_max, too.

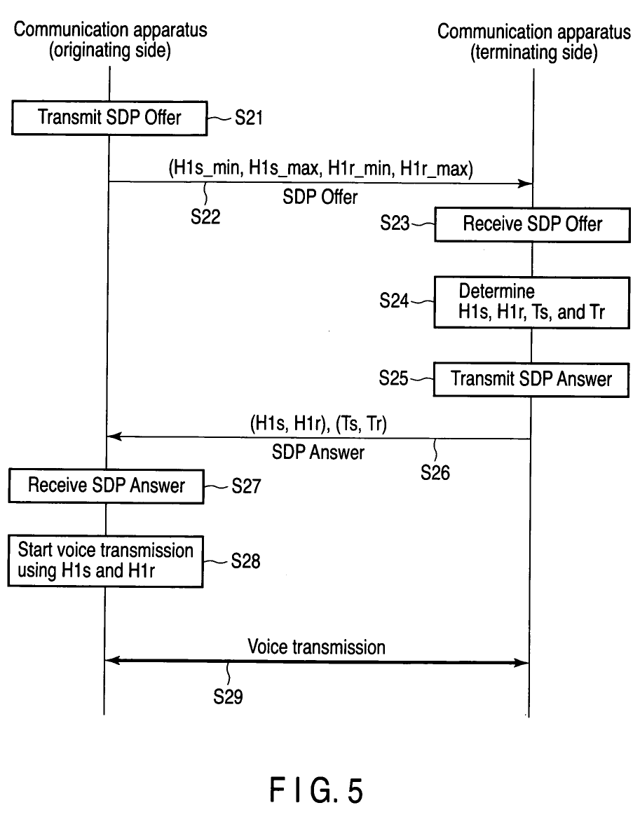

The operation of the communication system will be described in detail below with reference to FIGS. 3 to 5. FIG. 5 shows an operation sequence of negotiation by SDP between the communication apparatuses H1 and H2.

Referring to FIG. 5, reference symbol H1s denotes a transmission packet division length determined by the communication apparatus H2; H1r, a reception packet division length determined by the communication apparatus H2; Ts, a processing time taken for the communication apparatus H2 to transmit data having the length H1r; and Tr, a processing time taken for the communication apparatus H2 to receive data having the length H1s.

A case in which when one of the start inputs (1) to (5) exemplified above is detected, a change start is detected will be described.

First, the communication apparatus H1 on the originating side starts originating operation to the communication apparatus H2 on the terminating side.

At this time, the packet division length change detection unit 11 of the communication apparatus H1 detects a call originating operation as a start input (step S1).

Next, in the communication apparatus H1, the packet division length determination unit 12 determines the maximum and minimum values of the packet division length on the basis of external information (step S2). This is done so that by presenting a possible range of the packet division length as a range specified by the maximum and minimum values in negotiation, a negotiation partner (the communication apparatus H2 in this case) can determine the packet division length within the presented range in consideration of the processing load of its own.

In this case, a data length when voice data is divided into packets at an interval of 20 msec as an RTP recommended value is set to the minimum value of the packet division length as an initial value (step S11). The addition processes of the data length are executed on the initial value on the basis of external information (step S12 and subsequent steps).

First, for example, when a G.711 codec (64 kbps) executes voice transmission, the initial value is 160 bytes (64 kbps×20 msec=160 bytes).

Next, for example, when start information of another application such as a notepad or phone book application is used as the external information, the packet division length determination unit 12 adds a data length corresponding to the other active application to the minimum value. The data length to be added is predetermined for each application. For example, 100 bytes are added in the case of the notepad application, and 80 bytes are added in the case of the phone book application. If the notepad application is active and the phone book application is inactive, 100 bytes are added to the minimum value. If the notepad application is inactive and the phone book application is active, 80 bytes are added to the minimum value. If both of the applications are active, 100+80=180 bytes are added to the minimum value.

When, for example, information on whether the number of packets received per unit time at a network interface exceeds a threshold value is used as the external information, the packet division length determination unit 12 adds a predetermined data length to the minimum value upon detection of reception of the number of packets more than the threshold value. For example, the threshold value is set to 100 packets/sec and the data length to be added is set to 100 bytes in advance. When the number of packets received per unit time exceeds 100 packets/sec, 100 bytes are added to the minimum value.

On the other hand, the maximum value of the packet division length is set to a maximum possible length so that the total length of IP packets falls within the range of IPv6 path MTU (1500 bytes on Ethernet™) or IPv6 Minimum MTU (1280 bytes), in order to eliminate factors which lead to transmission delays and increases in the processing load of IPv6 fragment processing.

In an environment in which a voice transmission delay to be guaranteed by the system between the communication apparatuses H1 and H2 is limited, the maximum value is set so that the voice transmission delay falls within an acceptable range. If, for example, the system guarantees that the voice transmission delay is 150 msec or shorter, the maximum value is set to 1200 bytes (64 kbps×150 msec=1200 bytes).

Note that TCP/IP network processing includes processes, such as a checksum process and an internal process of copying data to a buffer, whose processing times prolong in proportion with the packet length. In a embedded device with low throughput, such processes greatly influence the voice transmission delay. When the maximum value of the packet division length is finally set, a value obtained by multiplying a delay coefficient by the TCP/IP network processing may be set to the maximum value.

Assume that the delay coefficient is given by measuring a TCP/IP network processing time corresponding to a packet length in advance. If, for example, the maximum value derived in consideration of each piece of the external information is 1200 bytes and the delay coefficient is 1.2, 1200 bytes×(1/1.2)=1000 bytes are set as the final maximum value of the data division length.

In the communication apparatus H1, the packet division length negotiation unit 13 starts negotiating the packet division length with the communication apparatus H2 (step S3).

The communication apparatus H1 transmits an SDP Offer message to the communication apparatus H2 via the signaling control unit 15 (steps S21 and S22). At this time, the communication apparatus H1 describes, in “a=line” as an SDP function extension field, the minimum and maximum values (H1s_min, H1s_max) of the transmission packet division length and those (H1r_min, H1r_max) of the reception packet division length. Note that it is possible to describe, in “a=line”, an attribute newly defined in a function extension field, and the like.

The communication apparatus H2 receives the SDP Offer message (steps S22 and S23).

The communication apparatus H2 which has received the SDP Offer message determines the transmission packet division length H1s and the reception packet length H1r on the basis of the range of (H1s_min, H1s_max) and that of (H1r_min, H1r_max) described in the SDP Offer message, respectively (step S24). The communication apparatus H2 may further determine Ts and Tr.

At this time, similar to the above-described procedure of determining the packet division length of the communication apparatus H1, the communication apparatus H2 calculates the maximum and minimum values of the transmission packet division length and those of the reception packet division length on the basis of the external information of its own, and determines the minimum H1s and H1r which fall within the ranges of the communication apparatuses H1 and H2. If, for example, (H1s_min, H1s_max) and (H1r_min, H1r_max) of the communication apparatus H1 are (440, 1000) and (440, 1000), respectively, and (H1s_min, H1s_max) and (H1r_min, H1r_max) of the communication apparatus H2 are (360, 1000) and (360, 1000), respectively, H1s=440 and H1r=440.

In the above explanation, (H1s_min, H1s_max) of the communication apparatus H2 represents the minimum and maximum values of the reception packet division length for the communication apparatus H2, and (H1r_min, H1r_max) of the communication apparatus H2 represents the minimum and maximum values of the transmission packet division length for the communication apparatus H2.

The communication apparatus H2 transmits an SDP Answer message to the communication apparatus H1 (steps S25 and S26).

At this time, the communication apparatus H2 describes H1s and H1r determined by itself in “a=line” of SDP.

If Ts and Tr are determined in step S24, the communication apparatus H2 also describes determined Ts and Tr.

The communication apparatus H1 receives the SDP Answer message (steps S26 and S27).

In the communication apparatus H1, the signaling control unit 15 which has received the SDP Answer message notifies, as a negotiation result, the packet division length negotiation unit 13 of H1s and H1r described in the SDP Answer message.

In the communication apparatus H1, the packet division length control unit 14 controls the media control unit 16 to execute voice transmission on the basis of the packet division lengths H1s and H1r as the negotiation result (step S4). That is, the media control unit 16 controls packet transmission on the basis of the packet division length H1s in transmission, and controls packet reception on the basis of the packet division length H1r in reception.

With this operation, voice transmission is executed between the communication apparatuses H1 and H2 (step S29).

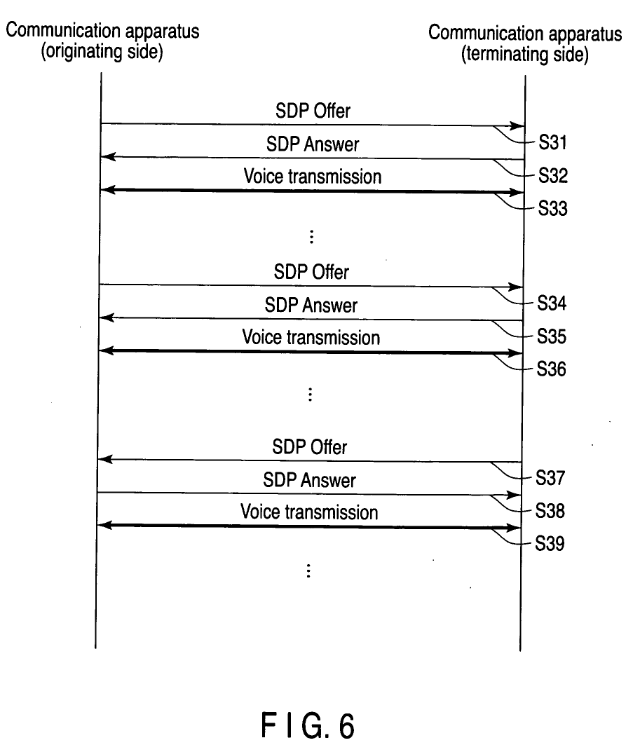

Such procedure in FIG. 5 may take place any number of times during the voice data transmission, as shown in FIG. 6.

Furthermore, as shown in FIG. 6, either of the originating communication apparatus H1 and the terminating communication apparatus H2 may detect start of changing the packet division length of voice data, and execute the procedure in FIG. 5. Referring to FIG. 6, the procedure in steps S31 to S33 and that in steps S34 to S36 are executed when the originating communication apparatus H1 detects a change start. The procedure in steps S37 to S39 is executed when the terminating communication apparatus H2 detects a change start.

Note that as a start input, only “in the communication apparatus H1, a call originating operation occurs” in item (1) above may be employed, or only “in the communication apparatus H2, a call terminating operation occurs” in item (2) above may be employed.

Both items (1) and (2) described above may be employed. In this case, the following situation can occur. That is, both of the packet division length change detection units 11 of the communication apparatuses H1 and H2 respectively detect change starts, and each of the communication apparatuses H1 and H2 transmits an SDP Offer message. In this case, the following rule is made. If, for example, the communication apparatus H1 receives an SDP Offer message from the communication apparatus H2 before detecting a change start and transmitting an SDP Offer message, it stops the process in execution, and continues the process based on the received SDP Offer message. If the communication apparatus H1 receives an SDP Offer message from the communication apparatus H2 after transmitting an SDP Offer message, it discards the received SDP Offer message.

In this embodiment, it is possible to notify a communication apparatus of parameters associated with a delay time in negotiation of the packet division length. The communication apparatus H2 can notify the communication apparatus H1 of the delay time of its own by additionally describing, in an SDP Answer message, the estimated value (e.g., the total value of a TCP/IP network reception processing time, a G.711 decoding processing time, and the like) Ts of the total time taken for the communication apparatus H2 to receive data having the length H1s, and the estimated value (e.g., the total value of a TCP/IP network transmission processing time, a G.711 encoding processing time, and the like) Tr of the total time taken for the communication apparatus H2 to transmit data having the length H1r. On the other hand, the communication apparatus H1 can calculate the total time taken to transmit and receive the data having the length H1s and that having the length H1r, respectively. Consequently, the communication apparatus H1 can estimate the voice transmission delay of the whole system between the communication apparatuses H1 and H2, thereby implementing an IP phone system in which the maximum value of a voice transmission delay is guaranteed with high accuracy.

As described above, in this embodiment, to divide voice data into packets and transmit them, it is possible to control the tradeoff between the processing load and voice quality by negotiating the packet division length between communication apparatuses and adjusting the packet division length.

As a result, it is possible to implement a voice call so that other communication processes and application processes are not interfered or such interference, if any, falls within an acceptable range in a embedded device with low or limited throughput.

The communication apparatus can be implemented by, e.g., using a general-purpose computer apparatus as basic hardware. That is, it is possible to implement the packet division length change detection unit 11, packet division length determination unit 12, packet division length negotiation unit 13, packet division length control unit 14, signaling control unit 15, media control unit 16, signaling transmission unit 17, signaling reception unit 18, media transmission unit 19, and media reception unit 20 by causing a processor mounted in the above computer apparatus to execute a program. In this case, the communication apparatus may be implemented by installing the program on the computer apparatus, or by storing the program in a storage medium such as a CD-ROM or distributing the program via a network, and installing the program on the computer apparatus as needed.

Note that the above-described functions can be described as software and executed by a computer having an appropriate mechanism.

The embodiment can be practiced as a program which causes a computer to execute a predetermined procedure, causes a computer to function as a predetermined means, or causes a computer to implement a predetermined function. The embodiment can also be practiced as a computer-readable recording medium which records the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus for dividing voice data into a plurality of packets and transmitting the packets to a destination communication apparatus, comprising:
a detection unit configured to detect one of predetermined events which are triggers of change processing of a packet division length used for the dividing;
a determination unit configured to determine, when the detection unit detects the one of the predetermined events, a range of the packet division length after the change processing based on predetermined external information which influence the packet division length;
a negotiation unit configured to negotiate the packet division length after the change processing with the destination communication apparatus based on the range determined by the determination unit; and
a control unit configured to control the transmitting based on the packet division length negotiated by the negotiation unit.

2. The apparatus according to claim 1, wherein one of the predetermined events is that a call originating operation starts for the transmitting in the communication apparatus, and
the detection unit instructs the determination unit to start the change processing upon detection of start of the call originating operation.

3. The apparatus according to claim 1, wherein one of the predetermined events is that a call terminating operation starts for the transmitting in the communication apparatus, and
the detection unit instructs the determination unit to start the change processing upon detection of start of the call terminating operation.

4. The apparatus according to claim 1, wherein one of the predetermined events is that the number of interrupts per unit time of packet reception processing exceeds a threshold value in the communication apparatus, and
the detection unit instructs the determination unit to start the change processing upon detection of the number of interrupts exceeding the threshold value.

5. The apparatus according to claim 1, wherein one of the predetermined events is that another application starts in the communication apparatus, and
the detection unit instructs the determination unit to start the change processing upon detection of start of the another application.

6. The apparatus according to claim 1, wherein one of the predetermined events is that a user inputs a specific instruction in the communication apparatus, and
the detection unit instructs the determination unit to start the change processing upon detection of input of the specific instruction.

7. The apparatus according to claim 1, wherein the range is represented by a maximum value and minimum value of the packet division length, and
the determination unit determines the maximum value and minimum value of the packet division length.

8. The apparatus according to claim 7, wherein to determine the minimum value, the determination unit executes a process of setting an initial value of the minimum value and, when a predetermined addition condition is met, executes a process of adding a value depending on the held addition condition to the minimum value.

9. The apparatus according to claim 7, wherein the determination unit determines the maximum value of the packet division length based on IPv6 minimum MTU.

10. The apparatus according to claim 7, wherein the determination unit determines the maximum value of the packet division length based on IPv6 path MTU.

11. The apparatus according to claim 7, wherein the determination unit determines the maximum value of the packet division length based on a delay coefficient by network processing.

12. The apparatus according to claim 11, wherein the delay coefficient is a coefficient given by measuring a network processing time corresponding to a packet length.

13. The apparatus according to claim 1, wherein the negotiation unit executes the negotiation using an SDP protocol.

14. The apparatus according to claim 1, wherein the negotiation unit executes the negotiation in consideration of an estimated value of a voice delay obtained from the range determined by the determination unit.

15. The apparatus according to claim 1, wherein the determination unit determines the range in transmitting the packets and that in receiving the packets individually,
the negotiation unit negotiates the packet division length at a time of the transmission and that at a time of the reception individually, and
the control unit controls transmission of the packets based on the packet division length at the time of the transmission, which has been negotiated by the negotiation unit, and controls reception of the packets based on the packet division length at the time of the reception, which has been negotiated by the negotiation unit.

16. A communication control method comprising:
detecting, before or during dividing voice data into a plurality of packets and transmitting the packets to a destination communication apparatus, one of predetermined events which are triggers of change processing of a packet division length used for the dividing;
determining, when the one of the predetermined events is detected in the detecting, a range of the packet division length after the change processing based on predetermined external information which influence the packet division length;
negotiating the packet division length after the change processing with the destination communication apparatus based on the range determined in the determining; and
controlling the transmitting based on the packet division length negotiated in the negotiating.

17. A computer readable storage medium storing instructions of a computer program which when executed by a computer results in performance of steps comprising:
detecting, before or during dividing voice data into a plurality of packets and transmitting the packets to a destination communication apparatus, one of predetermined events which are triggers of change processing of a packet division length used for the dividing;
determining, when the one of the predetermined events is detected in the detecting, a range of the packet division length after the change processing based on predetermined external information which influence the packet division length;
negotiating the packet division length after the change processing with the destination communication apparatus based on the range determined in the determining; and
controlling the transmitting based on the packet division length negotiated in the negotiating.
